(19) United States
(12) Patent Application Publication
(10) Pub. No.: US 2021/0221206 A1
(43) Pub. Date: Jul. 22, 2021

(54) SEALING STRUCTURE FOR VEHICLE DOOR

(71) Applicant: TOYOTA JIDOSHA KABUSHIKI KAISHA, Aichi-ken (JP)

(72) Inventor: Shunsuke KANAGAI, Anjo-shi (JP)

(21) Appl. No.: 17/060,087

(22) Filed: Oct. 1, 2020

(30) Foreign Application Priority Data
Jan. 22, 2020 (JP) 2020-008749

(51) Int. Cl. B60J 10/84; B60J 5/06; B60J 10/27

(52) U.S. Cl. CPC B60J 10/84; B60J 10/27; B60J 5/06

(57) ABSTRACT

A sealing structure for a vehicle door includes: a side-door opening provided on a vehicle; a sliding door provided to be shiftable between a closed position and an open position; and a second sealing member provided at the side-door opening. In the second sealing member, when the sliding door is placed at the closed position from the open position, a first lip portion moves toward the sliding door and comes into contact with the sliding door to prevent the entry of water into the vehicle from between the side-door opening and the sliding door. When the sliding door is placed at the open position from the closed position, the first lip portion moves away from the sliding door.

### CROSS-REFERENCE TO RELATED APPLICATION

This application claims priority to Japanese Patent Application No. 2020-008749 filed on Jan. 22, 2020, incorporated herein by reference in its entirety.

### BACKGROUND

### 1. Technical Field

The present disclosure relates to a sealing structure for a vehicle door.

### 2. Description of Related Art

Japanese Patent Application Publication No. 2011-46274 discloses a structure that prevents entry of water into a vehicle from between a door opening provided on a side portion of the vehicle and a sliding door that closes the door opening. In the structure described in the document, a sealing member functioning as a seal is provided at the door opening and the sliding door, and the sealing member is interposed between the door opening and the sliding door, thereby preventing the entry of water into the vehicle from between the door opening and the sliding door.

### SUMMARY

Meanwhile, in the structure where the sealing member for preventing the entry of water into the vehicle is provided at the door opening or its periphery, it is conceivable that the sealing member hinders an occupant from getting on and off the vehicle or a load from being loaded on and off the vehicle.

In view of the above fact, an object of the present disclosure is to obtain a sealing structure for a vehicle door capable of preventing a sealing member from hindering an occupant from getting on and off a vehicle and a load from being loaded on and off the vehicle.

A sealing structure for a vehicle door according to an aspect of the present disclosure includes: a door opening provided on a vehicle; a vehicle door provided to be shiftable between a closed position for closing the door opening and an open position for opening the door opening; and a sealing member provided at the door opening, the sealing member partially moving toward the vehicle door and coming into contact with the vehicle door to prevent the entry of water into the vehicle from between the door opening and the vehicle door when the vehicle door is placed at the closed position from the open position, the sealing member partially moving away from the vehicle door when the vehicle door is placed at the open position from the closed position.

According to the above aspect, when the vehicle door is placed at the closed position from the open position, at least a part of the sealing member moves toward the vehicle door and comes into contact with the vehicle door. In this state, the sealing member prevents the entry of water into the vehicle from between the door opening and the vehicle door. When the vehicle door is placed at the open position from the closed position, the sealing member is separated from the vehicle door. With such a configuration, it is possible to reduce the amount of protrusion of the sealing member from the door opening in a state where the vehicle door is placed at the open position. It is thus possible to prevent the sealing member from hindering an occupant from getting on and off the vehicle and a load from being loaded on and off the vehicle.

In the above aspect, the sealing member is provided along the vehicle's lower side of the door opening, the sealing member protrudes upward in the vehicle with respect to a floor surface in the vehicle in a state where the vehicle door is placed at the closed position, and the sealing member is stored downward in the vehicle with respect to the floor surface in a state where the vehicle door is placed at the open position.

With the above sealing structure for the vehicle door, in the state where the vehicle door is placed at the closed position, the sealing member protrudes upward in the vehicle with respect to the floor surface in the vehicle. Hence the sealing member keeps back water trying to enter the vehicle from between a lower side of the vehicle door and a lower side of the door opening. Further, in the state where the vehicle door is placed at the open position, the sealing member is stored downward in the vehicle with respect to the floor surface. With such a configuration, it is possible to reduce the amount of protrusion of the sealing member from the floor surface in the state where the vehicle door is placed at the open position. Therefore, for example, when a user of a wheelchair gets on the vehicle or gets off the vehicle, it is possible to prevent the sealing member from hindering a wheel of the wheelchair from rolling.

In the above aspect, a drain passage, in which water kept back by the sealing member flows toward the outside of the vehicle, is provided outward of the sealing member from the vehicle.

With the above sealing structure for the vehicle door, the water kept back by the sealing member can be allowed to flow toward the outside of the vehicle through the drain passage.

In the above aspect, the sealing member includes a first lip portion and a second lip portion that are placed separately from members constituting the vehicle door and the door opening, respectively, in the state where the vehicle door is placed at the open position, and the first lip portion and the second lip portion are in contact with the members constituting the vehicle door and the door opening, respectively, in the state where the vehicle door is placed at the closed position.

With the above sealing structure for the vehicle door, by providing the first lip portion and the second lip portion in the sealing member, it is possible to effectively prevent the entry of water into the vehicle from between the vehicle door and the first lip portion of the sealing member and the entry of water into the vehicle from between the door opening and the second lip portion of the sealing member.

In the above aspect, there is further provided an interlocking actuation unit that shifts the sealing member in coordination with the shifting of the vehicle door from the open position to the closed position or the shifting of the vehicle door from the closed position to the open position.

According to the sealing structure for the vehicle door, by providing the interlocking actuation unit, it is possible to shift the sealing member so as to be associated with the shifting of the vehicle door.

The sealing structure for the vehicle door according to the present disclosure has an excellent effect in that it is possible to prevent a sealing member from hindering an occupant from getting on and off the vehicle and a load from being loaded on and off the vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of a vehicle that an occupant of a wheelchair can ride, as viewed from an obliquely rear side;

FIG. 2 is a sectional view illustrating a cross-section of a side portion of the vehicle cut along a line 2-2 indicated in FIG. 1;

FIG. 3 is an enlarged sectional view illustrating a portion indicated by a chain line A in FIG. 2 in an enlarged manner and illustrates a state in which a side door is placed at a closed position in a configuration in which a second sealing member is provided;

FIG. 4 is an enlarged sectional view corresponding to FIG. 3 and illustrates a state in which the side door is placed at an open position;

FIG. 5 is a side view illustrating the second sealing member and the interlocking actuation unit;

FIG. 6 is a schematic view schematically illustrating a first interlocking actuation unit; and

FIG. 7 is a schematic view schematically illustrating a second interlocking actuation unit.

### DETAILED DESCRIPTION OF EMBODIMENTS

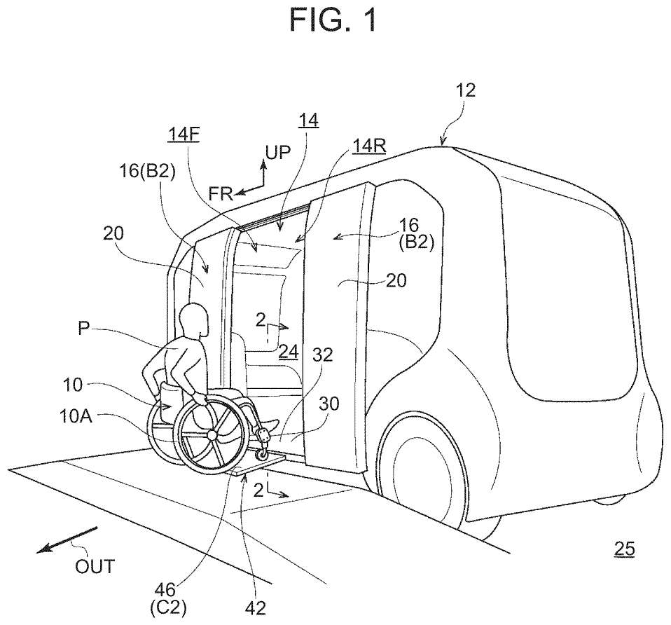

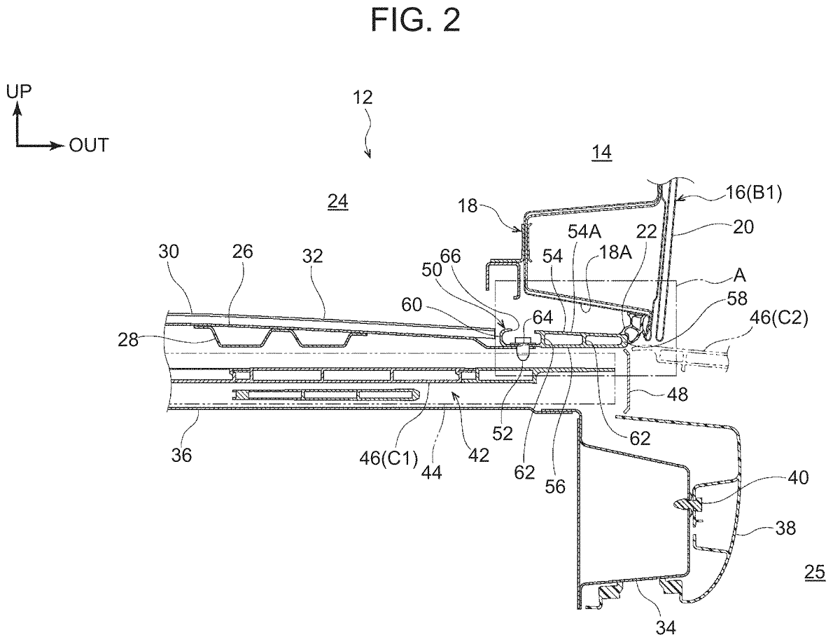

First, a schematic configuration of a vehicle will be described with reference to FIGS. 1 and 2. Next, with reference to FIGS. 1, 3, 4, and 5, a description will be given of a configuration of a second sealing member 68, which constitutes a main portion of a sealing structure for a vehicle door of the present embodiment, and an interlocking actuation unit.

Schematic Configuration of Vehicle

FIG. 1 illustrates a vehicle 12 that a user P of a wheelchair 10 can get on and off while sitting on the wheelchair 10. Herein, an arrow UP appropriately illustrated in each figure indicates an upward direction of the vehicle, an arrow FR indicates a forward direction of the vehicle, and an arrow OUT indicates a leftward direction of the vehicle which is one direction in a width direction of the vehicle. In the following description, when a description is given indicating a front-rear, right-left, or height direction, a front-rear, right-left, or height direction of the vehicle is indicated.

The vehicle 12 illustrated in FIG. 1 is a vehicle capable of automatically traveling without driving operation. A side-door opening 14 as a door opening formed in a rectangular shape in a side view of the vehicle (as viewed from the left side) is formed in a central portion of the vehicle 12 in the front-rear direction on one side (left side) in the vehicle width direction. The side-door opening 14 can be opened and closed by a pair of sliding doors 16 serving as a vehicle door. In the present embodiment, the front sliding door 16 closes a front region 14F of the side-door opening 14, and the rear sliding door 16 closes a rear region 14R of the side-door opening 14. A position of the pair of sliding doors 16 in a state where the pair of sliding doors 16 close the side-door opening 14 is called a closed position B1. The front sliding door 16 can be slid (shifted) forward from the state of being at the closed position B1, and the rear sliding door 16 can be slid (shifted) backward from the state of being at the closed position B1. The front sliding door 16 and the rear sliding door 16 slide forward and backward from the state of being at the closed position B1, respectively, to open the side-door opening 14. The position of the pair of sliding doors 16 in a state where the pair of sliding doors 16 open the side-door opening 14 is referred to as an open position B2. Further, in the present embodiment, a shape and the like of a rail supporting the pair of sliding doors 16 are set such that the pair of sliding doors 16 is offset by a predetermined distance to the outside in the vehicle width direction when the pair of sliding doors 16 slide from the closed position B1 to the open position B2.

As illustrated in FIG. 2, the pair of sliding doors 16 are configured by joining a window member 20 restricted in a panel shape to an outer portion, in the vehicle width-direction, of a frame portion 18 formed in a ladder shape in the side view of the vehicle, or by some other means. Since a whole or a part of the window member 20 is transparent, the window member 20 functions as window glass. A first sealing member 22 formed using a viscoelastic material such as rubber is attached to a lower end of the frame portion 18 of the sliding door 16. In the state where the pair of sliding doors 16 are at the closed position B1, the first sealing member 22 comes into contact with an outer end of a step member 50 to be described later in the vehicle width direction, thereby preventing water from entering the vehicle's inside 24 from between the pair of sliding doors 16 and the step member 50.

The vehicle 12 includes a floor panel 26 extending in the front-rear direction and the vehicle width direction on a lower side of the vehicle's inside 24. Note that load-bearing performance of the floor panel 26 is ensured by joining a reinforcing member 28, formed in a substantially W-shaped cross-section as viewed from the front side to a lower surface of the floor panel 26 or by some other means. A sheet-like member 30 formed in a sheet shape is joined to an upper surface of the floor panel 26. The upper surface of the sheet-like member 30 constitutes a floor surface 32 of the vehicle's inside 24.

The vehicle 12 is provided with a pair of right and left rockers 34 constituting frames on both sides of a lower portion of the vehicle 12 in the vehicle width direction. The pair of right and left rockers 34 are formed in a substantially rectangular cross-section as viewed from the front side of the vehicle. Note that only the left rocker 34 is illustrated in FIG. 2. A panel member 36 extending in the front-rear direction and the vehicle width direction is joined to upper portions of the pair of right and left rockers 34 while being stretched over the pair of right and left rockers 34. A rocker molding 38 is attached to an outer portion of the left rocker 34 in the vehicle width direction via a clip 40 or the like.

A slope unit 42 is provided between the floor panel 26 and the panel member 36 in a portion on one side (left side) in the vehicle width direction. The slope unit 42 includes a sloping rail 44 and a slope body 46 that moves along the sloping rail 44 from a state of being placed at a storage position C1 to be developed to a lateral side (left side) of the vehicle 12. In FIG. 2, an outer edge of the slope body 46 in a state of being placed at the storage position C1 is indicated by a solid line. The slope body 46 in a state of being placed at a development position C2 developed to the lateral side (left side) of the vehicle 12 is drawn by a two-dot chain line. The slope body 46 may be electrically moved from the storage position C1 to the development position C2 or from the development position C2 to the storage position C1, or may be moved manually. In the present embodiment, as an example, the slope body 46 is moved electrically. When the slope body 46 is placed at the storage position C1, the opening on one side in the vehicle width direction between the floor panel 26 and the panel member 36 is closed by a lid member 48. The lid member 48 may be formed integrally with the rocker molding 38.

The step member 50 constituting a part of the side-door opening 14 is attached to an end of the floor panel 26 on one side in the vehicle width direction at a location corresponding to the side-door opening 14 via a fastening member 52 such as a bolt. The step member 50 is formed in a long shape with the front-rear direction as a longitudinal direction by extrusion molding of an aluminum alloy or the like as an example. Specifically, the step member 50 includes an upper wall 54 extending in the front-rear direction with the height direction as a thickness direction, and a lower wall 56 extending in the front-rear direction with the height direction as the thickness direction and disposed below the upper wall 54. The step member 50 is provided with an outer wall 58 that connects, in the height direction, the outer end of the upper wall 54 in the vehicle width direction and an outer end of the lower wall 56 in the vehicle width direction, and an inner wall 60 that connects, in the height direction, an inner end of the upper wall 54 in the vehicle width direction and an inner end of the lower wall 56 in the vehicle width direction. Further, the step member 50 is provided with a single or a plurality of intermediate walls 62 connecting the upper wall 54 and the lower wall 56 in the height direction at a center portion in the vehicle width direction. An insertion hole 64 through which the fastening member 52 is inserted is formed in a portion inside the vehicle width of the lower wall 56. A passage hole 66, through which the fastening member 52 passes when the step member 50 is attached to the floor panel 26, is formed at a location corresponding to the insertion hole 64 of the lower wall 56 in a portion of the upper wall 54 inside the vehicle width.

In the state where the pair of sliding doors 16 are at the closed position B1, the first sealing member 22 prevents the entry of water to the vehicle's inside 24 from between the pair of sliding doors 16 and the step member 50. However, provision of an additional sealing member is considered depending on an environment in which the vehicle 12 is used, conditions for the contact between the first sealing member 22 and the step member 50, and the like. Hereinafter, a configuration in which the second sealing member 68 as the additional sealing member is provided will be described.

Configuration of Second Sealing Member 68

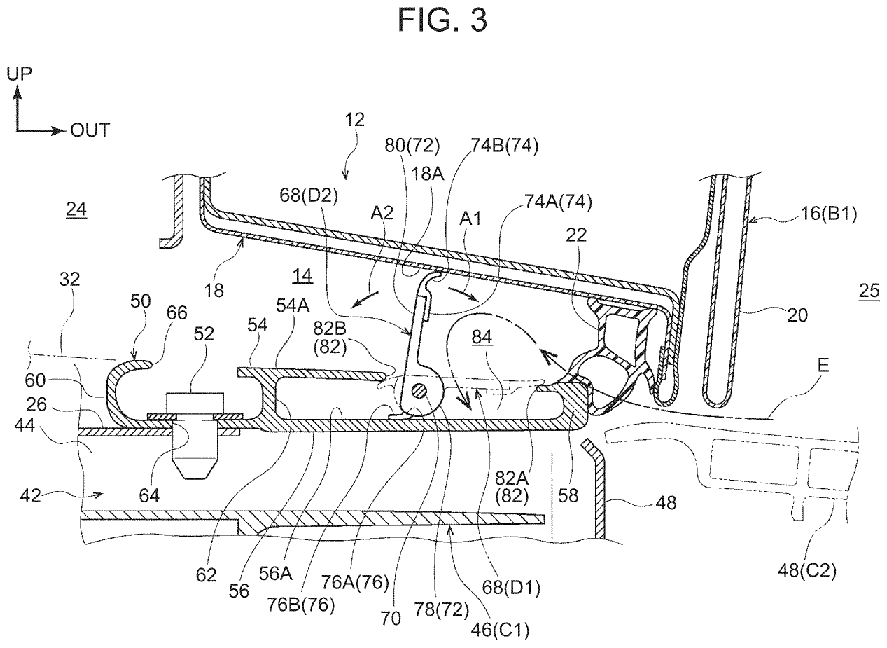

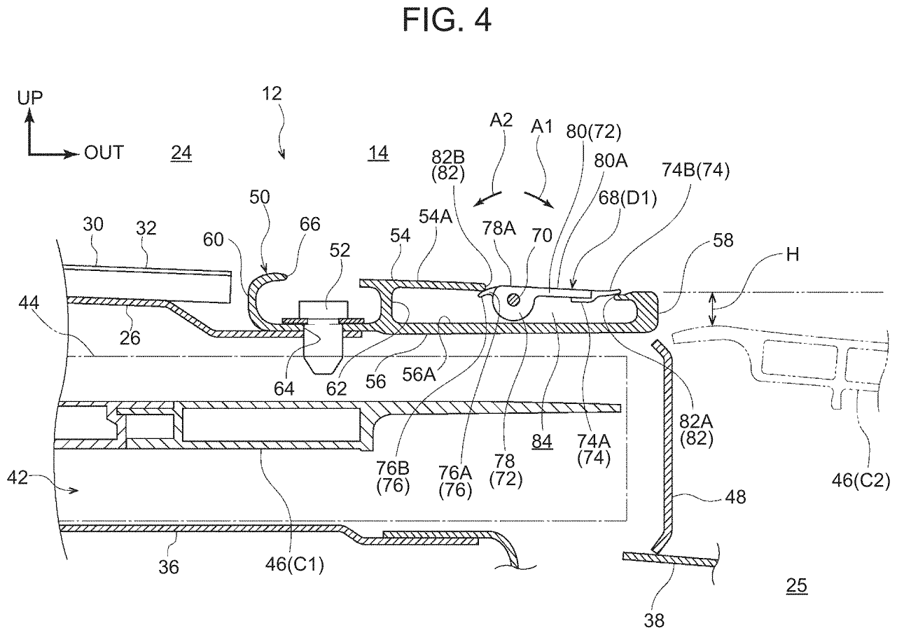

As illustrated in FIGS. 3 and 4, the second sealing member 68 is provided on the step member 50. The second sealing member 68 includes a shaft portion 70 locked to the step member 50, a seal body portion 72 integrally provided with the shaft portion 70 and tilted about the shaft portion 70, and a first lip portion 74 and a second lip portion 76 integrally provided with the seal body portion 72. In consideration of easiness of viewing the drawings, hatching of the cross-section of the second sealing member 68 in each drawing is omitted.

The shaft portion 70 and the seal body portion 72 are formed using a hard resin material. The seal body portion 72 includes a D-section portion 78 coaxially disposed with the shaft portion 70 and formed in a D-shaped cross-section, and a protruding plate portion 80 protruding from the D-section portion toward the opposite side from the shaft portion 70.

The first lip portion 74 is formed using a viscoelastic material such as rubber. A base end side 74A of the first lip portion 74 is joined to an end of the protruding plate portion 80 of the seal body portion 72 on the opposite side from the D-section portion 78. A tip side 74B of the first lip portion 74 is flexible and deformable with respect to the protruding plate portion 80 of the seal body portion 72.

The second lip portion 76 is formed using a viscoelastic material such as rubber similarly to the first lip portion 74. A base end side 76A of the second lip portion 76 is joined to an opposite side from the protruding plate portion 80 in the D-section portion 78 of the seal body portion 72. The tip side 76B of the second lip portion 76 is flexible and deformable with respect to the D-section portion 78.

Next, a configuration of a portion of the step member 50 in which the second sealing member 68 is provided will be described.

An opening 82, which is opened and closed by the second sealing member 68 when the second sealing member 68 is tilted, is formed in an outer portion of the upper wall 54 of the step member 50 in the vehicle width direction. The shaft portion 70 of the second sealing member 68 is locked to each of a front edge and a rear edge of the opening 82 formed in the upper wall 54 of the step member 50, so that the second sealing member 68 can be tilted with the front-rear direction as the axial direction.

As illustrated in FIG. 4, when the second sealing member 68 is tilted toward one side (arrow A1 side), the second sealing member 68 closes the opening 82 formed in the upper wall 54 of the step member 50. In this state, the first lip portion 74 of the second sealing member 68 is in contact, from above, with an outer edge 82A of the opening 82 in the vehicle width direction formed in the upper wall 54 of the step member 50, and the second lip portion 76 of the second sealing member 68 is in contact, from below, with an inner edge 82B of the opening 82 in the vehicle width direction formed in the upper wall 54 of the step member 50. In this state, an upper surface 78A of the D-section portion 78 of the second sealing member 68 and an upper surface 80A of the protruding plate portion 80 are substantially flush with an upper surface 54A of the upper wall 54 of the step member 50. A position of the second sealing member 68 in this state is called a storage position D1.

When the second sealing member 68 is tilted from the storage position D1 illustrated in FIG. 4 toward the other side (arrow A2 side), as illustrated in FIG. 3, the protruding plate portion 80 side of the second sealing member 68 moves upward with respect to the shaft portion 70, and the opposite side to the protruding plate portion 80 in the D-section portion 78 moves downward with respect to the shaft portion 70. Thus, the first lip portion 74 of the second sealing member 68 comes into contact with a lower surface 18A of the frame portion 18 of the sliding door 16, and the second lip portion 76 of the second sealing member 68 comes into contact with an upper surface 56A of the lower wall 56 of the step member 50. The position of the second sealing member 68 in a state where the first lip portion 74 and the second lip portion 76 can come into contact with the lower surface 18A of the frame portion 18 of the sliding door 16 and the upper surface 56A of the lower wall 56 of the step member 50, respectively, is referred to as an upright position D2. In a state where the second sealing member 68 is placed at the upright position D2, the opening 82 formed in the upper wall 54 of the step member 50 is open.

Further, an outer region in the vehicle width direction in a space surrounded by the upper wall 54, the outer wall 58, the lower wall 56, and the inner wall 60 of the step member 50 (i.e., a region of the second sealing member 68 outward of the D-section portion 78 in the vehicle width direction) serves as a drain passage 84 in which water kept back by the second sealing member 68 placed at the upright position D2 flows. The lower wall 56 of a portion corresponding to the drain passage 84 is formed with a discharge hole (not illustrated) configured to discharge water flowing in the drain passage 84 to the vehicle's outside 25.

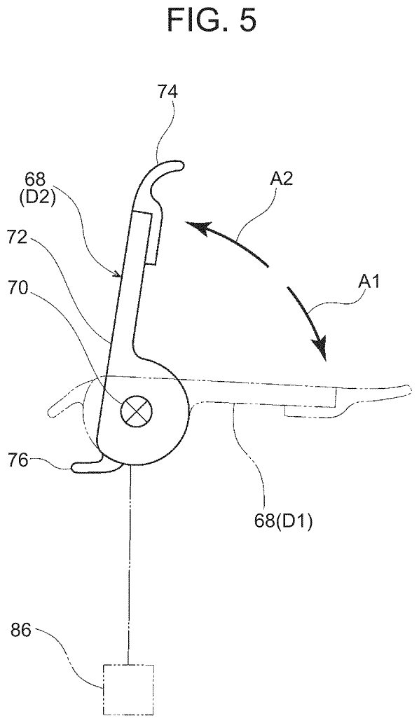

As illustrated in FIG. 5, the second sealing member 68 described above is tilted from the storage position D1 to the upright position D2 in coordination with the sliding of the sliding door 16 from the open position B2 (cf. FIG. 1) to the closed position B1 (cf. FIG. 3), and is tilted from the upright position D2 to the storage position D1 in coordination with the sliding of the sliding door 16 from the closed position B1 to the open position B2. The tilting of the second sealing member 68 is realized by an interlocking actuation unit 86. Note that a specific configuration of the interlocking actuation unit 86 will be described later in detail.

Actions and Effects of Configuration in which Second Sealing Member 68 is Provided

Next, a description will be given of actions and effects of the configuration in which the second sealing member 68 is provided.

As illustrated in FIG. 3, in the state where the sliding door 16 is positioned at the closed position B1, the first sealing member 22 is in contact with the outer end of the step member 50 in the vehicle width direction. Thus, the first sealing member 22 prevents the entry of water to the vehicle's inside 24 from between the sliding door 16 and the step member 50.

In the state where the sliding door 16 is at the closed position B1, the second sealing member 68 is placed at the upright position D2 by actuation of the interlocking actuation unit 86 (cf. FIG. 5), and the first lip portion 74 and the second lip portion 76 of the second sealing member 68 come into contact with the lower surface 18A of the frame portion 18 of the sliding door 16 and the upper surface 56A of the lower wall 56 of the step member 50, respectively. Thereby, water (arrow E of two-dot chain line) having passed through a contact portion between the first sealing member 22 and the step member 50 and entered inside in the vehicle width direction can be kept back by the second sealing member 68. Further, by providing the second lip portion 76 in addition to the first lip portion 74, it is possible to effectively prevent the entry of water to the vehicle's inside 24. In a case where the entry of water to the vehicle's inside 24 can be prevented even when the second lip portion 76 is not provided, the second lip portion 76 may not be provided.

The water kept back by the second sealing member 68 is discharged to the vehicle's outside 25 through the drain passage 84. It is thus possible to prevent the water kept back by the second sealing member 68 from remaining between the second sealing member 68 and the first sealing member 22. When an amount of water supposed to remain between the second sealing member 68 and the first sealing member 22 is small, the drain passage 84 may not be provided.

As illustrated in FIGS. 1 and 4, when the sliding door 16 is slid from the closed position B1 (cf. FIG. 3) to the open position B2, the second sealing member 68 is tilted from the upright position D2 to the storage position D1 by the actuation of the interlocking actuation unit 86 (cf. FIG. 5). Thus, the second sealing member 68 is stored downward in the vehicle with respect to the floor surface 32. As a result, it is possible to reduce an amount of upward protrusion of the second sealing member 68 from a lower portion of the side-door opening 14 and the floor surface 32 in the state where the sliding door 16 is placed at the open position B2. That is, it is possible to reduce unevenness caused by the provision of the second sealing member 68. It is thus possible to prevent the second sealing member 68 from hindering an occupant from getting on and off the vehicle and a load from being loaded on and off the vehicle. Especially, when the user P of the wheelchair 10 gets on the vehicle 12 or gets off the vehicle 12, it is possible to prevent the second sealing member 68 from hindering a wheel 10A of the wheelchair 10 from rolling. When the user P of the wheelchair 10 gets on the vehicle 12, the slope unit 42 is actuated, and the slope body 46 is placed at the development position C2. As an example, a height difference H of a step in the height direction between the slope body 46 placed at the development position C2 and the step member 50 is set to 6 mm or less.

In the example described above, the example has been described where the first lip portion 74 of the second sealing member 68 is brought into contact with or separated from the frame portion 18 of the sliding door 16 by tilting the second sealing member 68 in coordination with the sliding of the sliding door 16, but the present disclosure is not limited thereto. For example, the entire second sealing member may move in a predetermined locus in coordination with the sliding of the sliding door 16.

In the present embodiment, the example has been described where the second sealing member 68 is provided in the step member 50, but the present disclosure is not limited thereto. For example, the second sealing member 68 may be supported by the floor panel 26 or the like. The second sealing member 68 may be provided not only in the lower portion of the side-door opening 14 but also in a pillar, a roof side rail, and the like constituting a front edge, a rear edge, and an upper edge of the side-door opening 14. A sealing member having the same configuration as the second sealing member 68 may be provided in a back door opening or the like serving as a door opening.

In the present embodiment, the example has been described where the second sealing member 68 is provided in addition to the first sealing member 22, but the present disclosure is not limited thereto. For example, the sealing member corresponding to the first sealing member 22 may not be provided, and only a sealing member corresponding to the second sealing member 68 may be provided.

The configuration in which the second sealing member 68 is provided as described above can be used not only for the purpose of preventing a sealing member from hindering an occupant from getting on and off the vehicle and a load from being loaded on and off the vehicle, but also for the purpose of preventing foreign matter such as water from entering the vehicle's inside 24.

Specific Configuration of Interlocking Actuation Unit

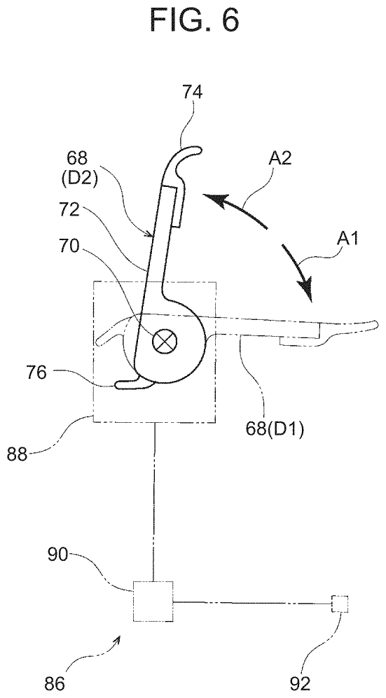

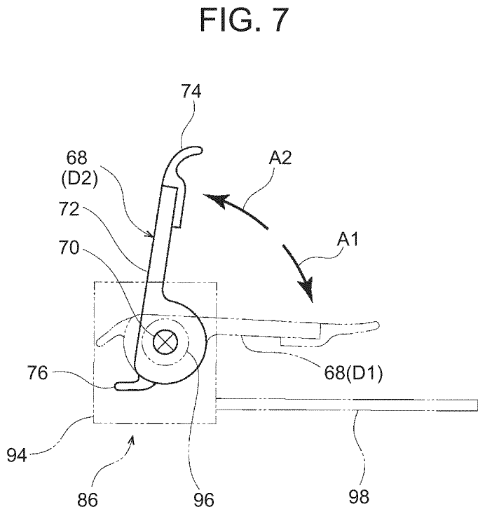

Next, a specific configuration of the interlocking actuation unit 86 will be described with reference to FIGS. 6 and 7.

As illustrated in FIG. 6, the first interlocking actuation unit 86 includes a motor actuator 88 that is energized to rotate the rotary shaft and tilt the second sealing member 68, a control unit 90 that controls the energization of the motor actuator 88, and a door switch 92 that detects that the sliding door 16 is at the closed position B1 (cf. FIG. 3).

In the interlocking actuation unit 86, in the state where the sliding door 16 is at the closed position B1, a part of the sliding door 16 comes into contact with the door switch 92, and the door switch 92 outputs a predetermined signal. When determining that the sliding door 16 is at the closed position B1 based on the signal from the door switch 92, the control unit 90 controls the energization of the motor actuator 88 to place the second sealing member 68 at the upright position D2.

In the state where the sliding door 16 is at the open position B2 (cf. FIG. 4), a part of the sliding door 16 is separated from the door switch 92, and the door switch 92 outputs a predetermined signal. When determining that the sliding door 16 is at the open position B2 based on the signal from the door switch 92, the control unit 90 controls the energization of the motor actuator 88 to place the second sealing member 68 at the storage position D1.

As illustrated in FIG. 7, a second interlocking actuation unit 86 includes a turning mechanism 94 that biases the second sealing member 68 to the storage position D1 and transmits a part of a force accompanying the movement of the sliding door 16 to the second sealing member 68 to tilt the second sealing member 68 to the upright position D2. The turning mechanism 94 is provided with a spiral spring 96 that turnably biases the second sealing member 68 to the storage position D1 side. The turning mechanism 94 is provided with a rod 98 that protrudes toward the sliding door 16.

In the interlocking actuation unit 86, in the state where the sliding door 16 is at the closed position B1, a part of the sliding door 16 is pushing in the rod 98. A force accompanying the pushing of the rod 98 is transmitted to the second sealing member 68, whereby the second sealing member 68 is placed at the upright position D2 against a biasing force of the spiral spring 96

In the state where the sliding door 16 is at the open position B2, a part of the sliding door 16 is separated from the rod 98. In this state, the second sealing member 68 is placed at the storage position D1 by the biasing force of the spiral spring 96.

Although the above two examples have been described as specific configurations of the interlocking actuation unit 86, the present disclosure is not limited thereto, but the second sealing member 68 may be tilted using the interlocking actuation unit 86 of another configuration.

Although one embodiment of the present disclosure has been described above, the present disclosure is not limited to the above, and it is needless to say that various modifications other than the above can be carried out within a range not deviating from the gist thereof.

What is claimed is:

1. A sealing structure for a vehicle door comprising:
a door opening provided on a vehicle;
a vehicle door provided to be shiftable between a closed position for closing the door opening and an open position for opening the door opening; and
a sealing member provided at the door opening, the sealing member partially moving toward the vehicle door and coming into contact with the vehicle door to prevent entry of water into the vehicle from between the door opening and the vehicle door when the vehicle door is placed at the closed position from the open position, the sealing member partially moving away from the vehicle door when the vehicle door is placed at the open position from the closed position.

2. The sealing structure for the vehicle door according to claim 1, wherein
the sealing member is provided along the vehicle's lower side of the door opening,
the sealing member protrudes upward in the vehicle with respect to a floor surface in the vehicle in a state where the vehicle door is placed at the closed position, and
the sealing member is stored downward in the vehicle with respect to the floor surface in a state where the vehicle door is placed at the open position.

3. The sealing structure for the vehicle door according to claim 1, wherein a drain passage, in which water kept back by the sealing member flows toward an outside of the vehicle, is provided outward of the sealing member from the vehicle.

4. The sealing structure for the vehicle door according to claim 1, wherein
the sealing member includes a first lip portion and a second lip portion that are placed separately from members constituting the vehicle door and the door opening, respectively, in the state where the vehicle door is placed at the open position, and
the first lip portion and the second lip portion are in contact with the members constituting the vehicle door and the door opening, respectively, in the state where the vehicle door is placed at the closed position.

5. The sealing structure for the vehicle door according to claim 1, further comprising an interlocking actuation unit that shifts the sealing member in coordination with shifting of the vehicle door from the open position to the closed position or shifting of the vehicle door from the closed position to the open position.
